(19) United States
(12) Patent Application Publication
(10) Pub. No.: US 2014/0237489 A1
(43) Pub. Date: Aug. 21, 2014

(54) APPLICATION IMPLEMENTATION METHOD AND DEVICE

(71) Applicants: Ru Zhang, Shenzhen City (CN); Qing Wang, Shenzhen City (CN); Xing Zeng, Shenzhen City (CN); Yunfeng Dai, Shenzhen City (CN); Yu Wu, Shenzhen City (CN)

(72) Inventors: Ru Zhang, Shenzhen City (CN); Qing Wang, Shenzhen City (CN); Xing Zeng, Shenzhen City (CN); Yunfeng Dai, Shenzhen City (CN); Yu Wu, Shenzhen City (CN)

(21) Appl. No.: 14/346,939

(22) PCT Filed: Sep. 20, 2012
(86) PCT No.: PCT/CN2012/081650

§ 371 Date: Mar. 24, 2014

(30) Foreign Application Priority Data
Nov. 7, 2011 (CN) 201110348337.8

(51) Int. Cl. G06F 9/54

(52) U.S. Cl. CPC G06F 9/541; G06F 2209/547
USPC 719/328

(57) ABSTRACT

One aspect of the disclosure provides an application implementation method. In one embodiment, the method comprises receiving a behavior configuration table of an application to be implemented. The behavior configuration table is sent by a service end and includes identifications of Application Programming Interfaces (APIs) and configuration information corresponding to behaviors contained in the application to be implemented. The method further comprises implementing the application to be implemented according to the identifications of the APIs and the configuration information corresponding to the behaviors contained in the application to be implemented.

### CROSS-REFERENCE TO RELATED APPLICATION

The present application is the National Stage of, and therefore claims the benefit of, International Application No. PCT/CN2012/081650 filed on Sep. 20, 2012, which claims the priority to Chinese Patent Application No. 201110348337.8, entitled “Application Implementation Method and Device”, filed on Nov. 7, 2011, each of which is incorporated herein by reference in its entirety.

### TECHNICAL FIELD

This application relates to the communication field and, more specifically, to an application implementation method and device.

### BACKGROUND

With the increasing improvement of software and hardware techniques, various software applications have been emerging one after another. Each type of software implements an application, with a variety of behaviors defined in the software. A client can implement the application corresponding to the software by executing the behaviors contained in the software.

At present, when developing software, a technical person encodes the various behaviors contained by the software in order in the software; after installing the software, the client can execute the various behaviors contained by the software in the order that these various behaviors are contained in the software, and after the client finishes executing these various behaviors contained by the software, the application corresponding to the software is thus implemented.

In the process of implementing the present disclosure, the inventors found out at least the following problems with the prior art.

Currently, the various behaviors contained by software are hardcoded into the software. If the application corresponding to the software is to be modified, the behaviors contained by the software can only be modified when the new version of the software is released, wherein its flexibility is insufficient and its development costs are higher.

### SUMMARY

One aspect of the disclosure provides an application implementation method. In one embodiment, the method comprises receiving a behavior configuration table of an application to be implemented. The behavior configuration table is sent by a service end and includes identifications of Application Programming Interfaces (APIs) and configuration information corresponding to behaviors contained in the application to be implemented. The method further comprises implementing the application to be implemented according to the identifications of the APIs and the configuration information corresponding to the behaviors contained in the application to be implemented.

One aspect of the disclosure provides an application implementation device. In one embodiment, the application implementation device comprises a receiving module and an implementing module. The receiving module receives a behavior configuration table of an application to be implemented. The behavior configuration table is sent by a service end and includes identifications of Application Programming Interfaces (APIs) and configuration information corresponding to behaviors contained in the application to be implemented. The implementing module implements the application to be implemented according to the identifications of the APIs and the configuration information corresponding to the behaviors contained in the application to be implemented.

### BRIEF DESCRIPTION OF THE DRAWINGS

Reference is now made to the following descriptions taken in conjunction with the accompanying drawings, in which:

FIG. 1 illustrates a first flow diagram of the application implementation method provided by Embodiment 1 of the present disclosure;

FIG. 2 illustrates a second flow diagram of the application implementation method provided by Embodiment 1 of the present disclosure;

FIG. 3 illustrates a third flow diagram of the application implementation method provided by Embodiment 1 of the present disclosure;

FIG. 4 illustrates a fourth flow diagram of the application implementation method provided by Embodiment 1 of the present disclosure;

FIG. 5 illustrates a flow diagram of an application implementation method provided by Embodiment 2 of the present disclosure; and

FIG. 6 illustrates a flow diagram of an application implementation device provided by Embodiment 3 of the present disclosure.

### DETAILED DESCRIPTION

To further explain the technical means adopted by the present disclosure to achieve its intended aims and the effects thereof, a detailed description of the specific implementations, structures, features and their effects of the information feedback method and the corresponding server set forth according to the present disclosure will be rendered in the following, by referring to the appended drawings and the preferable embodiments.

The aforementioned and other technical contents, features and effects of the present disclosure will be clearly presented in the following detailed description of some embodiments by referring to the appended drawings. By an explanation of the specific implementations, a deeper and more concrete understanding of the technical means adopted by the present disclosure to achieve its intended aims and the effects thereof can be attained. However, the appended drawings are only provided for the use of reference and illustration, but not for imposing any restriction on the present disclosure.

### Embodiment 1

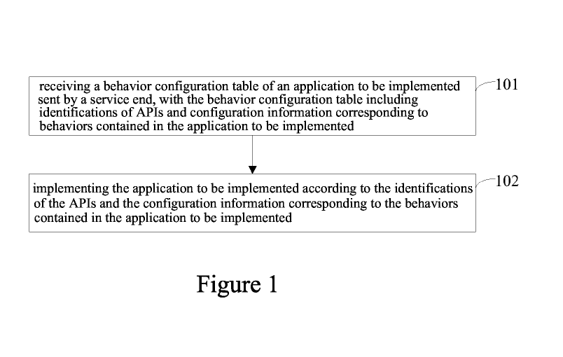

As shown in FIG. 1, this embodiment of the present disclosure provides an application implementation method, which comprises the following steps.

Step 101: receiving a behavior configuration table of an application to be implemented sent by a service end, with the behavior configuration table including identifications of APIs and configuration information corresponding to behaviors contained in the application to be implemented;

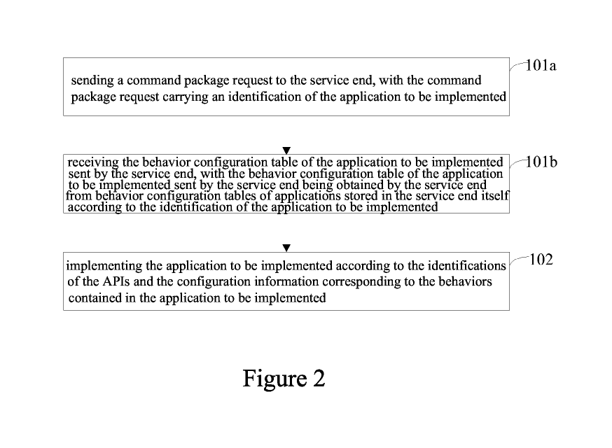

Step 102: implementing the application to be implemented according to the identifications of the APIs and the configuration information corresponding to the behaviors contained in the application to be implemented.

Wherein, by referring to FIG. 2, the above mentioned Step 101 can include:

Step 101a: sending a command package request to the service end, with the command package request carrying an identification of the application to be implemented;

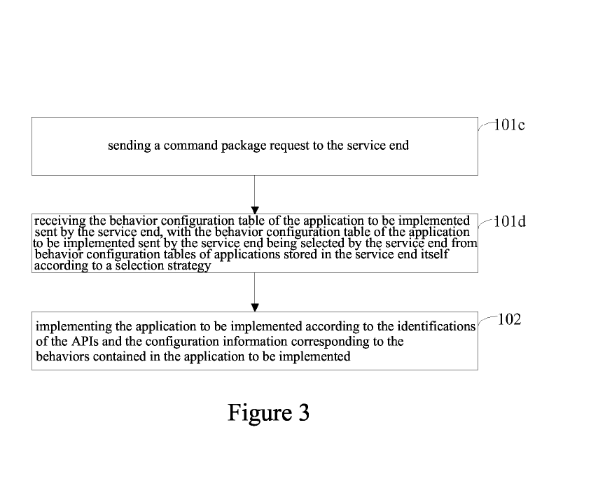

Step 101b: receiving the behavior configuration table of the application to be implemented sent by the service end, with the behavior configuration table of the application to be implemented sent by the service end being obtained by the service end from behavior configuration tables of applications stored in the service end itself according to the identification of the application to be implemented.

Wherein, by referring to FIG. 3, the above mentioned Step 101 can include:

Step 101c: sending a command package request to the service end;

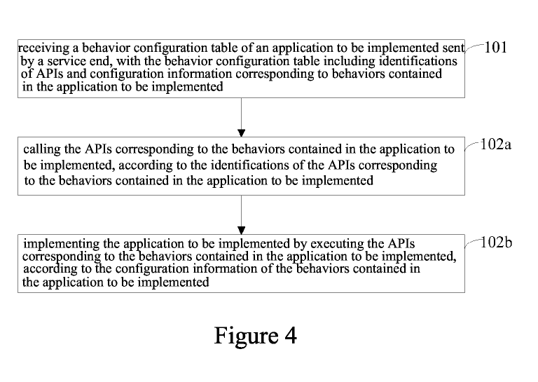

Step 101d: receiving the behavior configuration table of the application to be implemented sent by the service end, with the behavior configuration table of the application to be implemented sent by the service end being selected by the service end from behavior configuration tables of applications stored in the service end itself according to a selection strategy.

Wherein, by referring to FIG. 4, the above mentioned Step 102 can include:

Step 102a: calling the APIs corresponding to the behaviors contained in the application to be implemented, according to the identifications of the APIs corresponding to the behaviors contained in the application to be implemented;

Step 102b: implementing the application to be implemented by executing the APIs corresponding to the behaviors contained in the application to be implemented, according to the configuration information of the behaviors contained in the application to be implemented.

Further, before executing Step 102, the method can also comprise decrypting behavior configuration information of the application to be implemented, if the behavior configuration table of the application to be implemented is encrypted by the service end.

In this embodiment of the present disclosure, the behavior configuration table of the application to be implemented sent by the service end is received, with the behavior configuration table including the identifications of the APIs and the configuration information corresponding to the behaviors contained in the application to be implemented; and the application to be implemented is implemented according to the identifications of the APIs and the configuration information corresponding to the behaviors contained in the application to be implemented. Thus, when modifying the application to be implemented, the technical person only needs to modify at the service end the identifications of the APIs and the configuration information corresponding to the behaviors contained in the application to be implemented, which enables to improve the flexibility of modifying the application and reduce the development costs of modifying the application.

### Embodiment 2

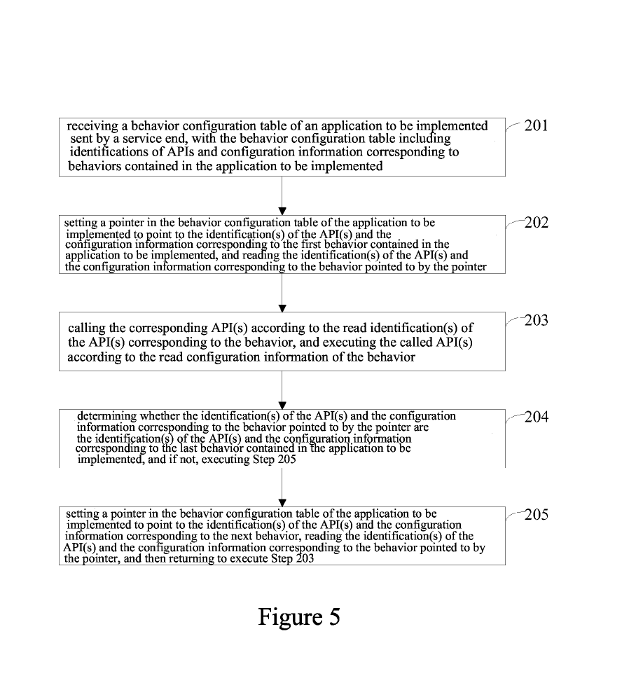

As shown in FIG. 5, this embodiment of the present disclosure provides an application implementation method, which comprises the following steps.

Step 201: receiving a behavior configuration table of an application to be implemented sent by a service end, with the behavior configuration table including identifications of APIs and configuration information corresponding to behaviors contained in the application to be implemented, with the configuration information of each behavior containing at least the configuration parameter(s) of each behavior.

Wherein, each behavior corresponds to one or more APIs; the specific process of a client implementing a certain behavior can be: the client calls the API(s) corresponding to the behavior, and executes the called API(s) according to the configuration information of the behavior, such as the configuration parameter(s) and so on. For example, the behavior to be implemented by the client is finding the file a.sis, the API to be called by the behavior is Find ( ) which is used to implement the finding function, and the configuration parameter of this behavior is the file name a.sis; the client calls Find ( ) to be called by the behavior, and finds the file a.sis via the called Find ( ) according to the configuration parameter a.sis of the behavior.

Wherein, the configuration information of the behavior can also include such information of the behavior as trigger condition, display regulation, implemented behavior description information and/or resulting behavior, etc.

Wherein, in this embodiment, the client can be a mobile phone, a personal computer, etc.; the service end can be a cloud, etc., with the cloud being a software platform comprising one or more servers.

Wherein, the technical person can configure at the service end the identifications of the APIs and the configuration information corresponding to various behaviors contained in the application to be implemented, and store the identifications of the APIs and the configuration information corresponding to various behaviors contained in the application to be implemented in the behavior configuration table in the order that the various behaviors contained in the application to be implemented are executed.

Wherein, the service end can select the behavior configuration table of the application to be implemented from behavior configuration tables of applications stored in the service end itself according to a selection strategy, and intuitively send the behavior configuration table of the application to be implemented to the client; or, the client sends a command package request to the service end, and the service end selects the behavior configuration table of the application to be implemented from the behavior configuration tables of the applications stored in the service end itself according to the selection strategy, and sends the behavior configuration table of the application to be implemented to the client; or, the client sends a command package request to the service end, with the command package request carrying an identification of the application to be implemented, and the service end obtains the behavior configuration table of the application to be implemented from the behavior configuration tables of the applications stored in the service end itself according to the identification of the application to be implemented carried by the command package request, and sends the behavior configuration table of the application to be implemented to the client. Wherein, the selection strategy can be that the behavior configuration table of the application that is most recently configured by the technical person is preferentially selected; for example, at the service end, the technical person firstly configures the behavior configuration table of application 1 and then configures the behavior configuration table of application 2; accordingly, the behavior configuration table of application 2 which has been most recently configured will be selected by the service end according to the selection strategy, and the behavior configuration table of application 2 that has been selected will be set as the behavior configuration table of the application to be implemented.

Further, before sending the command package request to the service end, the client can encrypt the command package request, and then send the encrypted command package request to the service end; accordingly, after receiving the command package request, the service end will firstly decrypt the received command package request, and then execute the step of obtaining the behavior configuration table of the application to be implemented.

Further, before sending the behavior configuration table of the application to be implemented to the client, the service end can encrypt the behavior configuration table of the application to be implemented, and then send the encrypted behavior configuration table of the application to be implemented to the client.

For example, the application to be implemented is to detect and kill the Trojan C in the client, and the process the client implements the application to be implemented is: finding the hidden file _a.sis, deleting the hidden file _a.sis, detecting and killing the processes A1 and A2, and then uninstalling the files a.sis and b.sis, thus achieving detecting and killing the Trojan C; wherein, the application to be implemented comprises behavior 1 for finding the hidden file _a.sis, behavior 2 for deleting the hidden file _a.sis, behavior for detecting and killing the processes A1 and A2, and behavior 4 for uninstalling the files a.sis and b.sis; the API corresponding to behavior 1 is Find ( ) which is used for finding files, the identification of Find ( ) is ID1, the configuration information of behavior 1 includes at least the configuration parameter of behavior 1, and the configuration parameter of behavior 1 is the file name a.sis; the API corresponding to behavior 2 is Delete ( ) which is used for deleting files, the identification of Delete ( ) is ID2, the configuration information of behavior 2 includes at least the configuration parameter of behavior 2, and the configuration parameter of behavior 2 is the file name _a.sis; the API corresponding to behavior 3 is Kill ( ) which is used for detecting and killing processes, the identification of Kill ( ) is ID3, the configuration information of behavior 3 includes at least the configuration parameters of behavior 3, and the configuration parameters of behavior 3 are the process names A1 and A2; the API corresponding to behavior 4 is Uninstall ( ) which is used for uninstalling files, the identification of Uninstall ( ) is ID4, the configuration information of behavior 4 includes at least the configuration parameters of behavior 4, and the configuration parameters of behavior 4 are the file names a.sis and b.sis.

Wherein, at the service end, the technical person configures the identification of the API and the configuration information corresponding to behavior 1 contained in the application to be implemented, the identification of the API and the configuration information corresponding to behavior 2 contained in the application to be implemented, the identification of the API and the configuration information corresponding to behavior 3 contained in the application to be implemented, and the identification of the API and the configuration information corresponding to behavior 4 contained in the application to be implemented, respectively; and stores the identification of the API and the configuration information corresponding to behavior 1 contained in the application to be implemented, the identification of the API and the configuration information corresponding to behavior 2 contained in the application to be implemented, the identification of the API and the configuration information corresponding to behavior 3 contained in the application to be implemented, and the identification of the API and the configuration information corresponding to behavior 4 contained in the application to be implemented in the behavior configuration table as shown in Table 1.

TABLE 1

| | Identification | Configuration |
|---|---|---|
| Behavior | of API | Information |
| Behavior 1 | ID1 | _a.sis |
| Behavior 2 | ID2 | _a.sis |
| Behavior 3 | ID3 | A1 and A2 |
| Behavior 4 | ID4 | a.sisi and b.sis |

Wherein, after the behavior configuration table of the application to be implemented as shown in Table 1 is configured by the technical person at the service end, the service end can send the behavior configuration table of the application to be implemented as shown in Table 1 to the client.

Step 202: setting a pointer in the behavior configuration table of the application to be implemented to point to the identification(s) of the API(s) and the configuration information corresponding to the first behavior contained in the application to be implemented, and reading the identification(s) of the API(s) and the configuration information corresponding to the behavior pointed to by the pointer.

Further, if the behavior configuration table of the application to be implemented is encrypted by the service end, the client will firstly decrypt the behavior configuration table of the application to be implemented and then execute this step.

For example, the client receives the behavior configuration table of the application to be implemented as shown in Table 1 sent by the service end, sets the pointer in the behavior configuration information of the application to be implemented as shown in Table 1 to point to the identification of the API and the configuration information corresponding to behavior 1, and reads the identification ID1 of the API and the configuration information _a.sis corresponding to behavior 1 pointed to by the pointer;

Step 203: calling the corresponding API(s) according to the read identification(s) of the API(s) corresponding to the behavior, and executing the called API(s) according to the read configuration information of the behavior.

Wherein, various APIs are defined in the operating system of the client, with each API having a corresponding identification, and therefore the client can call the corresponding API(s) from the operating system of the client according to the read identification(s) of the API(s) corresponding to the behavior.

For example, according to reading the identification ID1 of the API corresponding to behavior 1, the client calls the corresponding API Find ( ) from the operating system of the client, and finds the corresponding hidden file _a.sis by executing the called Find ( ) according to the configuration information _a.sis of behavior 1, hence completes the execution of behavior 1.

Step 204: determining whether the identification(s) of the API(s) and the configuration information corresponding to the behavior pointed to by the pointer are the identification(s) of the API(s) and the configuration information corresponding to the last behavior contained in the application to be implemented, and if not, executing Step 205.

Wherein, if the client determines that the identification(s) of the API(s) and the configuration information corresponding to the behavior pointed to by the pointer are the identification(s) of the API(s) and the configuration information corresponding to the last behavior contained in the application to be implemented, then it completes the implementing of the application to be implemented, and ends the operation.

Step 205: setting a pointer in the behavior configuration table of the application to be implemented to point to the identification(s) of the API(s) and the configuration information corresponding to the next behavior, reading the identification(s) of the API(s) and the configuration information corresponding to the behavior pointed to by the pointer, and then returning to execute Step 203.

Wherein, after reading the identification(s) of the API(s) and the configuration information corresponding to the last behavior contained in the application to be implemented, calling the API(s) corresponding to the last behavior, and executing the called API(s) according to the configuration information of the last behavior, the client completes the execution of the last behavior contained in the application to be implemented, that is, completes the implementing of the application to be implemented.

For example, the client determines that the identification of the API and the configuration information corresponding to behavior 1 pointed to by the pointer is not the identification of the API and the configuration information corresponding to the last behavior contained in the application to be implemented, and then sets the pointer in the behavior configuration table of the application to be implemented as shown in Table 1 to point to the identification of the API and the configuration information corresponding to behavior 2; reads the identification ID2 of the API and the configuration information _a.sis corresponding to behavior 2 pointed to by the pointer, calls the corresponding API, Delete ( ) from the operating system of the client according to the identification ID2 of the API corresponding to behavior 2, and deletes the hidden file _a.sis by executing the called Delete ( ) according to the configuration information a.sis of behavior 2.

The client determines that the identification of the API and the configuration information corresponding to behavior 2 pointed to by the pointer is not the identification of the API and the configuration information corresponding to the last behavior contained in the application to be implemented, and then sets the pointer in the behavior configuration table of the application to be implemented as shown in Table 1 to point to the identification of the API and the configuration information corresponding to behavior 3; reads the identification ID3 of the API and the configuration parameters A1 and A2 corresponding to behavior 3 pointed to by the pointer, calls the corresponding API, Kill ( ) from the operating system of the client according to the identification ID3 of the API corresponding to behavior 3, and detects and kills the processes A1 and A2 by executing the called Kill ( ) according to the configuration parameters A1 and A2 of behavior 3.

The client determines that the identification of the API and the configuration information corresponding to behavior 3 pointed to by the pointer is not the identification of the API and the configuration information corresponding to the last behavior contained in the application to be implemented, and then sets the pointer in the behavior configuration table of the application to be implemented as shown in Table 1 to point to the identification of the API and the configuration information corresponding to behavior 4; reads the identification ID4 of the API and the configuration parameters a.sis and b.sis corresponding to behavior 4 pointed to by the pointer, calls the corresponding API, Uninstall ( ) from the operating system of the client according to the identification ID4 of the API corresponding to behavior 4, and deletes the files a.sis and b.sis by executing the called Uninstall ( ) according to the configuration parameters a.sis and b.sis of behavior 4.

The client determines that the identification of the API and the configuration information corresponding to behavior 4 pointed to by the pointer is the identification of the API and the configuration information corresponding to the last behavior contained in the application to be implemented, and thus, completes the implementing of the behavior to be implemented, namely that the Trojan C is detected and killed, and ends the operation.

In this embodiment of the present disclosure, the behavior configuration table of the application to be implemented sent by the service end is received, with the behavior configuration table including the identifications of the APIs and the configuration information corresponding to the behaviors contained in the application to be implemented; and the application to be implemented is implemented according to the identifications of the APIs and the configuration information corresponding to the behaviors contained in the application to be implemented. Thus, when modifying the application to be implemented, the technical person only needs to modify at the service end the identifications of the APIs and the configuration information corresponding to the behaviors contained in the application to be implemented, which enables to improve the flexibility of modifying the application and reduce the development costs of modifying the application.

### Embodiment 3

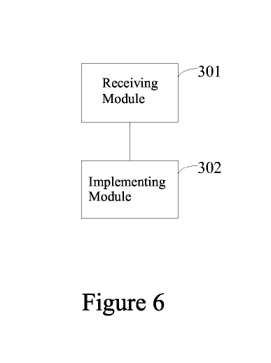

As shown in FIG. 6, this embodiment of the present disclosure provides an application implementation device, which comprises the following modules:

a receiving module 301, for receiving a behavior configuration table of an application to be implemented sent by a service end, with the behavior configuration table including identifications of APIs and configuration information corresponding to behaviors contained in the application to be implemented;

an implementing module 302, for implementing the application to be implemented according to the identifications of the APIs and the configuration information corresponding to the behaviors contained in the application to be implemented.

Wherein, the receiving module 301 comprises:

a first sending unit, for sending a command package request to the service end, with the command package request carrying an identification of the application to be implemented; and

a first receiving unit, for receiving the behavior configuration table of the application to be implemented sent by the service end, with the behavior configuration table of the application to be implemented sent by the service end being obtained by the service end from behavior configuration tables of applications stored in the service end itself according to the identification of the application to be implemented.

Wherein, the receiving module 301 comprises:

a second sending unit, for sending a command package request to the service end; and

a second receiving unit, for receiving the behavior configuration table of the application to be implemented sent by the service end with the behavior configuration table of the application to be implemented sent by the service end being selected by the service end from behavior configuration tables of applications stored in the service end itself according to a selection strategy.

Wherein, the implementing module 302 comprises:

a calling unit, for calling the APIs corresponding to the behaviors contained in the application to be implemented, according to the identifications of the APIs corresponding to the behaviors contained in the application to be implemented; and

an executing unit, for implementing the application to be implemented by executing the APIs corresponding to the behaviors contained in the application to be implemented, according to the configuration information of the behaviors contained in the application to be implemented.

Further, the device also comprises:

a decrypting module, for decrypting behavior configuration information of the application to be implemented, if the behavior configuration table of the application to be implemented is encrypted by the service end. In this embodiment of the present disclosure, the behavior configuration table of the application to be implemented sent by the service end is received, with the behavior configuration table including the identifications of the APIs and the configuration information corresponding to the behaviors contained in the application to be implemented; and the application to be implemented is implemented according to the identifications of the APIs and the configuration information corresponding to the behaviors contained in the application to be implemented. Thus, when modifying the application to be implemented, the technical person only needs to modify at the service end the identifications of the APIs and the configuration information corresponding to the behaviors contained in the application to be implemented, which enables to improve the flexibility of modifying the application and reduce the development costs of modifying the application.

It should be noted that: in the application being implemented by an application implementation device provided by the abovementioned embodiment, the abovementioned division of functional modules is only presented as an example for the purpose of explanation. In an actual application, the abovementioned functions can be distributed to different functional modules according to the actual needs and be completed, that is, the internal structure of the device is divided into different functional modules, so as to achieve all or a part of the functions described above. In addition, the application implementation device provided by the above mentioned embodiment belongs to the same idea with the embodiments of the application implementation method, with the specific implementation process being described in detail in the method embodiments, so that won't be covered again here.

Those of ordinary skill in the art can understand that all or a part of the steps implementing the above mentioned embodiments can be achieved by hardware, or by a program which instructs the relevant hardware, wherein the program can be stored in a non-transitory computer-readable storage medium, wherein the aforesaid storage medium can be a read-only memory, a disk or an optical disk, etc.

The abovementioned contents are only presented as the embodiments of the present disclosure, and do not constitute any restriction in any form on the present disclosure. Although the present disclosure has been disclosed in terms of the embodiments as mentioned above, these embodiments are not intended to put any restriction on the present disclosure. Utilizing the technical contents disclosed above, any person skilled in the art can make some amendments or modifications to become equivalent embodiments, without going beyond the scope of the technical solutions of the present disclosure. Any simple amendment, equivalent change and modification made to the above embodiments according to the technical essence of the present disclosure, without going beyond the content of the technical solutions of the present disclosure, still falls within the scope of the technical solutions of the present disclosure.

In the present disclosure, a behavior configuration table of an application to be implemented sent by a service end is received, with the behavior configuration table including the identifications of the APIs and the configuration information corresponding to the behaviors contained in the application to be implemented; and the application to be implemented is implemented according to the identifications of the APIs and the configuration information corresponding to the behaviors contained in the application to be implemented. Thus, when modifying an application to be implemented, the technical person only needs to modify at the service end the identifications of the APIs and the configuration information corresponding to the behaviors contained in the application to be implemented, which enables to improve the flexibility of modifying the application and reduce the development costs of modifying the application.

What is claimed is:

1. An application implementation method, comprising:
receiving a behavior configuration table of an application to be implemented sent by a service end, with the behavior configuration table including identifications of Application Programming Interfaces (APIs) and configuration information corresponding to behaviors contained in the application to be implemented; and
implementing the application to be implemented according to the identifications of the APIs and the configuration information corresponding to the behaviors contained in the application to be implemented.

2. The method of claim 1, wherein the receiving a behavior configuration table of an application to be implemented sent by a service end comprises:
sending a command package request to the service end, with the command package request carrying an identification of the application to be implemented; and
receiving the behavior configuration table of the application to be implemented sent by the service end, with the behavior configuration table of the application to be implemented sent by the service end being obtained by the service end from behavior configuration tables of applications stored in the service end itself according to the identification of the application to be implemented.

3. The method of claim 1, wherein the receiving a behavior configuration table of an application to be implemented sent by a service end comprises:
sending a command package request to the service end; and
receiving the behavior configuration table of the application to be implemented sent by the service end, with the behavior configuration table of the application to be implemented sent by the service end being selected by the service end from behavior configuration tables of applications stored in the service end itself according to a selection strategy.

4. The method of claim 1, wherein the implementing the application to be implemented according to the identifications of the APIs and the configuration information corresponding to the behaviors contained in the application to be implemented comprises:
calling the APIs corresponding to the behaviors contained in the application to be implemented, according to the identifications of the APIs corresponding to the behaviors contained in the application to be implemented; and
implementing the application to be implemented by executing the APIs corresponding to the behaviors contained in the application to be implemented, according to the configuration information of the behaviors contained in the application to be implemented.

5. The method of claim 1, wherein before implementing the application to be implemented according to the identifications of the APIs and the configuration information corresponding to the behaviors contained in the application to be implemented, the method further comprising:
decrypting behavior configuration information of the application to be implemented, if the behavior configuration table of the application to be implemented is encrypted by the service end.

6. An application implementation device, comprising:
a receiving module, for receiving a behavior configuration table of an application to be implemented sent by a service end, with the behavior configuration table including identifications of Application Programming Interfaces (APIs) and configuration information corresponding to behaviors contained in the application to be implemented; and
an implementing module, for implementing the application to be implemented according to the identifications of the APIs and the configuration information corresponding to the behaviors contained in the application to be implemented.

7. The device of claim 6, wherein the receiving module comprises:
a first sending unit, for sending a command package request to the service end, with the command package request carrying an identification of the application to be implemented; and
a first receiving unit, for receiving the behavior configuration table of the application to be implemented sent by the service end, with the behavior configuration table of the application to be implemented sent by the service end being obtained by the service end from behavior configuration tables of applications stored in the service end itself according to the identification of the application to be implemented.

8. The device of claim 6, wherein the receiving module comprises:
a second sending unit, for sending a command package request to the service end; and
a second receiving unit, for receiving the behavior configuration table of the application to be implemented sent by the service end, with the behavior configuration table of the application to be implemented sent by the service end being selected by the service end from behavior configuration tables of applications stored in the service end itself according to a selection strategy.

9. The device of claim 6, wherein the implementing module comprises:
a calling unit, for calling the APIs corresponding to the behaviors contained in the application to be implemented, according to the identifications of the APIs corresponding to the behaviors contained in the application to be implemented; and
an executing unit, for implementing the application to be implemented by executing the APIs corresponding to the behaviors contained in the application to be implemented, according to the configuration information of the behaviors contained in the application to be implemented.

10. The device of claim 6, wherein the device further comprises:
a decrypting module, for decrypting behavior configuration information of the application to be implemented, if the behavior configuration table of the application to be implemented is encrypted by the service end.
